(19) United States
(12) Patent Application Publication
(10) Pub. No.: US 2017/0090600 A1
(43) Pub. Date: Mar. 30, 2017

(54) IDENTIFYING PRESSURE INTENSITY AS A PRESSURE GESTURE IN A PRESSURE-SENSOR-LESS TOUCH SCREEN

(71) Applicant: INPRIS INNOVATIVE PRODUCTS LTD, Efrat (IL)

(72) Inventors: Ben-Etzion Yaron, Efrat (IL); Nissan Yaron, Efrat (IL)

(21) Appl. No.: 15/276,243

(22) Filed: Sep. 26, 2016

Related U.S. Application Data
(60) Provisional application No. 62/232,540, filed on Sep. 25, 2015.

(51) Int. Cl. G06F 3/0346; G06F 3/041

(52) U.S. Cl. CPC G06F 3/0346; G06F 3/0412; G06F 3/0416; G06F 2203/04105

(57) ABSTRACT

The methods, devices, and systems according to the teachings herein are related to the identification of a motion on a surface that is characteristic of a sway type motion (i.e., a rocking type motion) of a finger. The sway type motion may be employed by itself or in conjunction with one or more additional movements. The recognition of a sway type motion may be employed for controlling a device or for entering a character. The recognition of a sway type motion may be based on the change of location of the contact and/or one or more changes to a shape feature of the contact (or a rate of change of one or both). Preferably, the recognition of a sway type motion is based on both a feature related to the motion of the center of the contact (e.g., a rate of travel, a travel distance, a linearity of travel) and a feature related to a change in shape of the contact.

### FIELD

The present teachings relate to methods for entering text and/or control commands and devices for entering text and/or control commands. The methods and devices may employ the identification of a confirmation motion (such as a swaying motion) for confirming an entry. The method and devices may employ a swaying motion for continuous control of a device having multiple settings.

### BACKGROUND

In mechanical a mechanical controller, control of a device may be based on the pressure applied to the switch. For example, a joystick may control a device where the amount of pressure exerted on the joystick is employed for determining the amount by which a controllable feature on a device should be changed. Similarly, a pressure sensitive button may be able to use the level of pressure exerted on the button to determine the amount by which a controllable feature on a device should be changed. Such mechanical devices typically return to a base position upon removal of the pressure.

When using a touch screen, it generally is not possible to measure an actual pressure.

Approximation of a pressure may be made based on the area of a contact with a device. Various methods for measuring pressure or changes in pressure includes those described in US Patent Application Publications 2015/0261330 (Jalali, published Sep. 17, 2015); 2015/0160779 (Huang et al., published Jun. 11, 2015), 2014/0300559 (Tanimoto et al., published Oct. 9, 2014), 2014/0028606 (Giannetta, published Jan. 30, 2014), 2011/0291948 (Stewart et al., published Dec. 1, 2011), and U.S. Pat. No. 8,436,828 (Zhai, published May 7, 2013), the contents of which are incorporated herein by reference in their entirety.

However, pressure measurement based on contact area is often inaccurate due to the large variations in finger sizes of an individual and between individuals, and due to changes in shape of fingers, such as after prolonged or continuous pressing against a surface. For example, a finger may be characterized by an anelastic behavior, where the shape of the finger is deformed upon pressing and only gradually returns to an original shape upon removal of the pressure. As another example, the methods may require calibration or otherwise storing historical information related to contact area sizes.

Other approaches including using a displacement of a contact to enter a “pseudo-pressure.” For example, a finger may be slid in a direction from a base point and the amount of the displacement may be employed as a “pseudo-pressure.” Such approaches do not automatically return to a base location and it is dependent on a user to look at a display on a touch surface to return to a base location or to remember accurately the amount of displacement that was made and then attempt to return by the same distance.

There is a need to be able to control a device and/or enter characters using a motion that automatically returns to a base location (e.g., an initial location) where a pseudo-pressure is determined corresponding to one or more features of the motion.

### SUMMARY

It has been determined that a swaying motion of a finger provides an elegant means for controlling a device using a contact between a finger and a surface. As used herein, a swaying motion is a rocking motion of a finger starting at one location of a finger and moving towards another location of a finger. During a swaying motion, there is static friction between the finger and the surface. Such a motion is generally void of any dynamic friction. Thus, static friction is the predominant force (or only force) between the finger and the surface. This is in contrast to a swiping or sliding motions in which a single region of a finger travels along a surface. Although a swaying motion may be a rolling motion from one side of a finger towards another side of a finger (e.g., rolling from the bottom of a finger to the left side of a finger), the preferred swaying motion is a rocking motion along the length of the finger (e.g., from one phalanx of a finger towards another phalanx of the same finger).

Such a swaying motion provides a number of interesting features as discussed herein.

First, the swaying motion provides a level of displacement that can be measured by the circumferential travel along the finger. Thus, the return of the swaying motion can be controlled by a user by returning the finger to the same initial contact position of the finger, without needing to visually confirm that the finger has returned to the initial contact location of the surface.

Second, the swaying motion has features that distinguish the contact from a swiping contact. With a swaying motion, the contact area generally increases as the finger rocks from contact by a distal phalanx towards a contact with a middle phalanx and vise a versa. Such a feature is not seen in swiping motions, and can be employed to identify that a contact is indeed a swaying motion contact and/or to provide a “pseudo-pressure” measurement.

Third, the shape of the contact changes as the finger rocks in a swaying motion. For example, the contact between a finger and a surface may be generally circular (e.g., when a fingertip contacts the surface) and may become generally elliptical as the finger rocks towards the middle phalanx. The contact between the finger and the surface may be characterized by a length (in the direction of the length of a finger) and a width (in the direction of the width of a finger) and it is seen that the ratio of the length to width changes during the swaying motion. Similarly, the length of the contact will generally change with the swaying motion. Again, these features can be employed to identify a swaying motion and/or to provide a “pseudo-pressure measurement.”

### BRIEF DESCRIPTION OF THE DRAWINGS

FIG. 1 is an illustrative drawing of a side of a finger illustrating features that may be observed in a sway type motion of the finger.

FIGS. 2A, 2B, 2C, and 2D illustrate the contact of a finger to a surface during a sway type motion. FIG. 2A illustrates the finger in a first orientation during a sway having a first angle 31 relative to the surface. FIG. 2B illustrates the finger at a second orientation having a second angle 33 relative to the surface. FIG. 2B illustrates the finger at a third orientation having a third angle 35 relative to the surface. FIG. 2D shows an overlay of the orientations of FIG. 2A, 2B, and 2C.

FIGS. 3A, 3B, 3C, 3D, 3E, 3F, 3G, 3H, 3J, and 3K illustrate features of changes in the shape and location of the contact of a finger on a surface at sequential times during a swaying motion. FIG. 3A shows an illustrative location and shape of the contact of the finger at time t₀. FIG. 3B shows an illustrative location and shape of the contact of the finger at time t₁. FIG. 3C shows an illustrative location and shape of the contact of the finger at time t₂. FIG. 3D shows an illustrative location and shape of the contact of the finger at time t₃. FIG. 3E shows an illustrative location and shape of the contact of the finger at time t₄. FIG. 3F shows an illustrative location and shape of the contact of the finger at time t₅. FIG. 3G shows an illustrative location and shape of the contact of the finger at time t₆. FIG. 3H shows an illustrative location and shape of the contact of the finger at time t₇. FIG. 3J shows an illustrative location and shape of the contact of the finger at time t₈. FIG. 3K shows an illustrative location and shape of the contact of the finger at time t₉.

FIG. 4 is an illustrative contact curve illustrating features of the travel distance and the contact area that may be observed in a swaying motion.

FIG. 5 is an illustrative top view of a surface having a plurality of fingers contacting the surface.

FIG. 6 illustrates features of a process for controlling a device or entering a character employing the recognition of a sway type motion.

FIG. 7 illustrates features of a process for controlling a device or entering a character employing the changing of a sway type motion.

FIG. 8 illustrates features of a process for controlling a device or entering a character employing the removal of a sway type motion.

### DETAILED DESCRIPTION

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The ability to identify a motion on a surface that is consistent with a swaying type motion of a finger in which the finger rocks in a forward direction, a reverse direction or both, may be employed for entering a control command or a character by a user.

The swaying type motion may be characterized by a generally linear motion of a contact on a surface. The swaying motion may be distinguished from a swiping type motion of a contact on a surface. For example, the swaying motion may be distinguished by a change in one or more dimensions of the contact with the surface. Generally, when swaying from a fingertip towards a middle phalanx, a dimension of the contact with the surface increases. Examples of dimensions that may increase include a length of the contact, a surface area of the contact, a width of the contact, a ratio of the length to surface area of the contact, or any combination thereof.

Definitions

Positive swaying direction. A positive swaying direction refers to a rocking motion of a finger in a direction from the distal phalanx towards the middle phalanx of the finger.

Negative swaying direction. A negative swaying direction refers to a rocking motion of a finger in a direction from a middle phalanx towards a distal phalanx.

Swaying motion refers to a rocking motion of a finger in a positive swaying direction and/or a negative swaying direction. The swaying motion may be characterized by a motion in which dynamic friction between the surface and the finger is substantially or totally avoided.

Initial sway refers to the first swaying motion from an initial contact location.

Return sway refers to a second swaying motion from a position away from the initial contact location back towards the initial contact location. The return sway may return part ways to the initial contact location, completely to the initial contact location, or beyond the initial contact location.

A partial sway refers to a swaying motion in only one direction (e.g., only an initial sway).

A complete sway refers to a swaying motion in two or more directions (e.g., at least an initial sway and a return sway).

The standard deviation of a contact motion refers to the standard deviation of measured contacts locations relative to a straight line during a partial sway.

A swaying motion may be characterized by one or any combination of the following features: (1) a motion having a travel distance of about 2 mm or more (preferably about 4 mm or more, more preferably about 7 mm or more, and most preferably about 10 mm or more), as measured from the center of an initial contact location at an initial time to the center of a second contact location a second time after the initial time; (2) a motion that is substantially or entirely linear (e.g., the ratio of the standard deviation of the contact to the travel distance during a partial sway is about 30 percent or less, preferably about 20 percent or less, more preferably about 10 percent or less, and most preferably about 5 percent or less); (3) a motion that is characterized by a change in at least one size of a contact (e.g., a length of contact, an area of a contact; a length to width ratio of a contact, or any combination thereof) of about 5% or more (preferably about 10% or more, more preferably about 20% or more, and most preferably about 33% or more; (4) a motion that is characterized by a rate of about 0.01 mm/sec or more (preferably about 0.10 mm/sec or more, more preferably about 0.5 mm/sec or more, and most preferably about 2 mm/sec or more; (5) a motion that is characterized by a rate of about 500 mm/sec or less (preferably about 200 mm/sec or less, more preferably about 100 mm or less, and most preferably about 50 mm or less); or any combination thereof.

Upon identifying a contact on a surface, the processor preferably monitors the movement of the contact. Upon identifying a contact on a surface. the process preferably monitors one or more characteristics of the shape of the contact. Most preferably, the process includes a step of monitoring both the movement of a contact and one or more characteristics of a shape of a contact.

In a typical swiping type motion, after an initial contact is made with a surface, the movement of the contact is typically characterized by the following features: a contact that maintains a generally uniform contact area, a contact that moves at a generally uniform rate, a contact that maintains a generally uniform length, a contact that generally maintains a generally uniform width, a contact having a generally small aspect ratio (e.g., an aspect ratio of a length to width of about 1.5 or less). Due to the unique changes in the shape of a contact during a swaying motion as discussed herein, it is possible for a processor to identify a swaying motion as a type of motion distinct from a swiping motion.

In a typical point press type contact with a surface by a finger, the contact is generally free of motion of the center of the contact. Furthermore, the area of the contact may have minimal changes over time. After a contact is initiated, the area of the contact generally changes by less than 30% over time based on the amount of pressure applied to the surface. Due to the motion of the center of the contact and the unique changes in shape of the contact during a swaying motion as discussed herein, it is possible for a process to identify a swaying motion as a type of motion distinct from a press type contact.

The method may include a step of a process identification one, two or more contacts on a surface.

Device

The control devices according to the teachings herein include a processor and one or more components for measuring the location of a contact on a surface and one or more features of the shape of the contact (e.g., the contact area, the contact length, the contact length to width aspect ratio, or any combination thereof), and a processor for receiving the information on the location and shape of the contact and determining whether the contact is characteristic of a sway motion.

The methods and systems according to the teachings herein preferably employs a touch sensitive surface as a component in an input device for inputting commands. As used herein, a touch sensitive surface is capable of identifying the location of multiple simultaneous contacts on the surface. Each contact preferably includes a sufficient force applied to the surface as required by the touch sensitive surface to recognize a contact. The touch sensitive surface may be a flat surface, may be a curved surface, or may have regions that are flat and regions that are curved. Preferably the touch sensitive surface is characterized as being generally smooth and or having a generally uniform texture. For example, the touch sensitive surface may be sufficiently smooth and/or have a sufficiently uniform texture so that a user cannot identify the location of contact of the surface based on the surface topography or other tactile clues on the surfaces.

The touch sensitive surface may be a surface of a pure entry component or device (i.e., a component or a device that does not display images), such as a touch pad, or may be a surface of a combination entry/display component or device, such as a touch-screen display.

The device including the touch sensitive surface and/or a processor connected to the device preferably is capable of recognizing each of multiple contacts to the surface, the maintaining of the contact, the movement (if any) of the contact, and the termination (i.e., removal) of the contact.

The teachings herein may be employed for a sway keyboard. In a sway keyboard, a sway motion is employed for selecting a character to be entered or typed. For example, a finger may move along a surface contacting different regions and the device may broadcast the character associated with the region being contacted. The character may be selected by making a sway motion on the surface, initiating at the region associated at the desired character. A sway in a single direction versus a sway in multiple directions may be employed to distinguish between a lower case and an upper case character. Alternatively, a swipe motion (e.g., a linear swipe, a curved swipe, or a circular swipe) following the sway motion may be employed for selecting a feature of the character (e.g., upper case vs. lower case), or even for typing special non-alphabet characters.

The teachings herein enable the entry of a command using a hand without moving the hand from an initial starting location. Because a rocking/swaying motion is employed, the starting location is generally maintained when the swaying is returned.

The teachings herein may include a calculation of a rate of change of one or more features of the shape of a contact (e.g., the rate of change of a contact area) and/or a rate of change of a location of a contact (e.g., a rate of change of the travel distance of a contact). Preferably, the sway motion is identified by comparing the rate of change of the location of a contact to a critical value (of the contact movement rate) and a rate of change of the contact area to a critical value (of the contact area change rate). When the measured values are above (or maintained, such as maintained for a critical time) the critical values, the sway motion may be positively identified. It will be appreciated that the selection of the critical values may be based on the desirability to identify all sway type motions as compared to the desirability to avoid erroneously identifying a motion as a sway type motion.

The measurement of the contact location and the shape related feature(s) of the contact may occur at regular time intervals. Preferably, such measurements are obtained at a time interval of about 150 milliseconds or less, more preferably about 80 milliseconds or less, even more preferably about 30 milliseconds or less, even more preferably about 20 milliseconds or less, and most preferably about 10 milliseconds or less.

The devices, systems, and methods according to the teachings herein may provide for the calculation of one or more features related to the linearity of a motion of a contact. For example, the standard deviation of a series of contact points during the motion of the contact may be employed to determine the linearity of the contact. Similarly, features related to an arcuate shape of a series of contacts may be employed for determining that a contact motion is nonlinear.

The surface may be a touch sensitive surface. The touch surface may include unique areas associated with one or more different characters or commands.

The process may include the use of three or more simultaneous contacts to identify the arc shape of the contacts so that the sway direction of each contact may be determined. For example, the process may include fitting an arc to three contacts, identifying a center / focal point of the arc, and defining the positive sway direction for each contact point as the as the direction form the contact point to the center/focal point.

The process may be employed for controlling a device or a feature of a device having multiple settings. The device may change between settings after the sway type motion has been identified. The rate of change between settings may be constant or may vary depending on one or more measures of the swaying motion. For example, the rate of change may be related to the distance of travel of the sway motion (e.g., from an initial location), the rate of change may be related to the change in a feature of the shape of the contact (e.g., the contact area) or both. The process may be employed for controlling the opening or closing a window (either at a constant rate or at a variable rate). The process may be employed for controlling a radio (e.g., increasing and/or decreasing the volume, scrolling through station settings). The process may be employed for setting a clock. The process may be employed for setting one or more features of an HVAC system (e.g., a temperature setting, a fan speed setting, a location setting).

The process may employ one or more critical values for identifying a sway type motion. For example, the process may employ a critical travel distance and/or a critical change in shape of the contact, or both. The critical values may be predefined. One or more features of the initial contact may be employed for scaling or otherwise setting a critical value. A process may include a separate step of calibration for determining a critical value. Preferably, the process employs only predetermined critical values (i.e., without the need for a calibration step).

The contact may be an integrated contact that includes a swaying motion and one or more swiping motions before and/or after the swaying motion. Here, the combination of the motions may determine the command entry to be entered and/or a control level (e.g., an amount of change to a variable control device).

The process may include a step of recognizing (e.g., by a processor) a plurality of simultaneous contacts (e.g., two or more, or three or more) on a surface. This may be employed to identify a plurality of initial contact regions each associated with one of the contacts. The process may include a step of recognizing (e.g., by a processor) the maintaining of a contact at a first contact location while recognizing the removal of one or more of the other contacts (e.g., all of the other contact locations), such as the removing of a contact at a second contact location and/or a third contact location. The control command and/or character to be entered by be at least partially identified by the contact location for which contact is maintained. The start of an entry may also rely on measuring a contact time and starting the command entry mode after the contact is maintained for a critical contact time.

The devices, methods, and systems according to the teachings herein may include one or more of the features for assigning a contact location and/or identifying a contact location and/or associating a contact with a character or command as described in US Patent Application Publication 2012/0268389, US Patent Application Publication 2016/0110095, U.S. patent application Ser. No. 15/255,555 (filed on Sep. 2, 2016), U.S. patent application Ser. No. 15/241,381 (filed on Aug. 19, 2016), U.S. patent application Ser. No. 15/090,061 (filed on Apr. 4, 2016), each incorporated herein by reference in their entirety.

The devices, methods, and systems according to the teachings herein may employ a non-sway contact. For example, a sway type contact may be preceded by and/or followed by a contact that is a non-sway contact (e.g., a swipe contact). For purposes of illustration, the direction of a non-swipe contact may be employed for identifying a feature or a device to be controlled and then followed by a sway contact for controlling the feature of the device. As another example, the sway type contact may initiate the control and then a direction of swipe may be employed for adjusting a level of the device or feature being controlled.

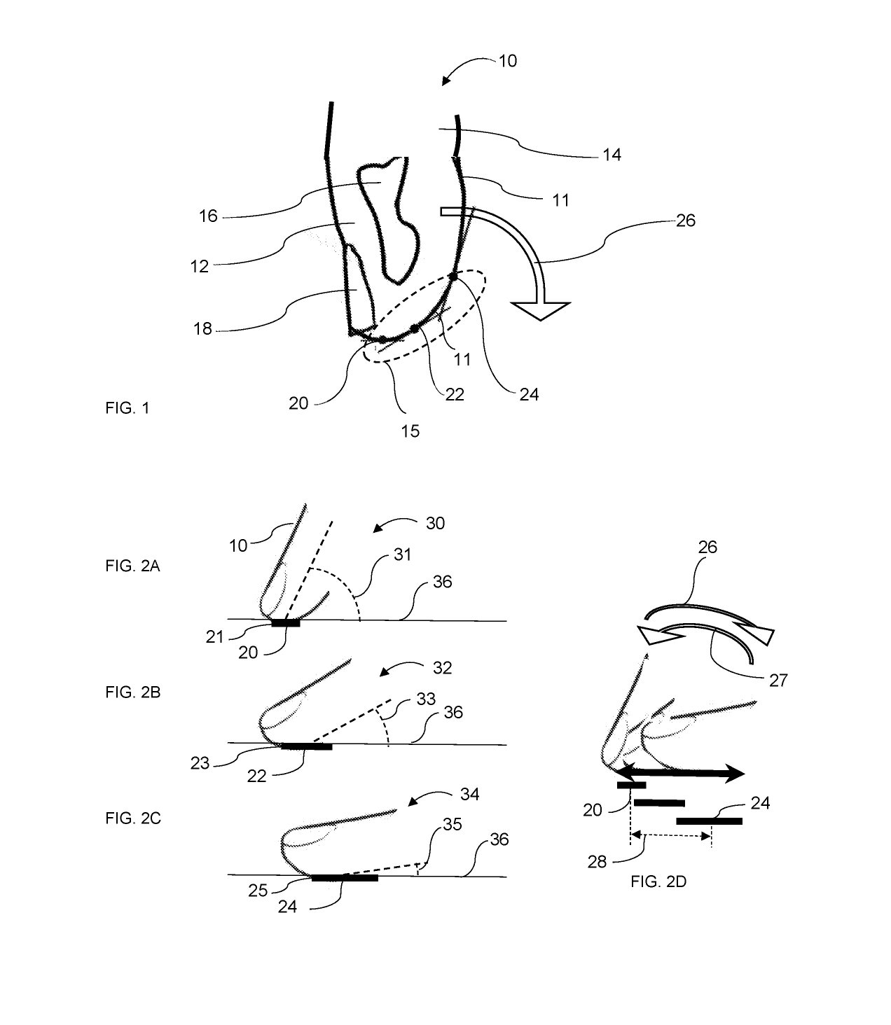

FIG. 1 is a side view of a finger 10 showing the distal phalanx 12 and a portion of the middle phalanx 14. The finger 10 may be oriented at a generally high angle (e.g., about 40° or more, 45° or more, or about 50° or more) relative to a surface so that the contact with the surface will be at or near the fingertip region 15 (e.g., at the P1 contact point or location 20). The orientation of the finger 10 in FIG. 1 may also identified by the fingernail 18 and bone 16. As the finger sways (e.g., rocks) in a forward sway direction 26, the center of the contact between the finger and a surface will move in the direction from the distal phalanx 12 (e.g., the fingertip 20) towards the middle phalanx 14. For example, the contact during a forward sway 26 may progress from a P1 contact point or location 20 to a P2 contact point or location 22 to a P3 contact location 24. It will be appreciated that depending on an individual's finger characteristics (such as length of fingernail and shape of finger) and/or an individual's preferences, the locations of the contact points or locations may be moved in a proximal or a distal direction. During the sway, there is generally continuous contact maintained between the finger 10 and the surface. The contact preferably is substantially or entirely free of swiping motion (in which dynamic friction occurs between the finger and the surface). Instead, a surface 11 of the finger generally rocks against the surface of a device. Preferably, the center points of contact on the surface during a sway motion is substantially or entirely linear. It will be appreciated that the distance of travel of the center point of contact on the surface during a sway may vary depending on multiple factors. Factors that may influence the distance of travel include the length of the finger, the orientation of the touch surface, the length of the fingernail, and an individual's capabilities (e.g., dexterity, flexibility, medical conditions or other influences).

FIG. 2A, 2B, 2C, and 2D illustrate the contact of a finger 10 with a surface 36 during a sway motion. The orientation of the finger 10 in FIG. 2A may be such that the center of contact is at a P1 contact point 20. The length 21 of the contact on the surface is relatively short. As the finger rocks in a positive sway direction 26, the angle between the finger and the surface decreases. At the P1 contact point, the finger 10 forms a relatively high angle 31. At a P2 contact point 22, the angle 33 between the finger 10 and the surface 36 may be decreased relative the angle 31 at the P1 contact point 20, such as illustrated in FIG. 2B. Similarly, at a P3 contact point 24, the angle 35 between the finger 10 and the surface 36 may be decreased relative the angle 33 at the P2 contact point 22, such as illustrated in FIG. 2C. At the P2 contact point 22, the length 23 of the contact is greater than the length 21 of the contact at the P1 contact point 20. At the P3 contact point 24, the length 25 of the contact is greater than the length 23 of the contact at the P2 contact point 22. With reference to FIG. 2D, the travel distance 28 of the contact may be about equal to the curvilinear distance of the finger between two contact points (e.g., between a first contact point and a later contact point). FIG. 2D illustrates the motion of the finger in a forward sway direction 26 and in a reverse sway direction 27. The sway may be characterized by a generally continuous contact of the finger with the surface. The sway may be characterized by a contact that increases in length and/or area as the sway moves in a forward sway direction. The sway may be characterized by a contact that decreases in length and/or area as the sway moves in a reverse sway direction. The sway may be characterized by a travel that is generally linear. The sway may be characterized by a contact that both (i) moves (preferably in a linear direction) and (ii) changes in length and/or area. The sway may be characterized by an aspect ratio of the contact length to the contact width that changes during the sway (e.g., an increasing ratio during a say in a positive sway direction and/or a decreasing ratio during a sway in a negative sway direction). The sway movement may be characterized by one or more of the aforementioned features.

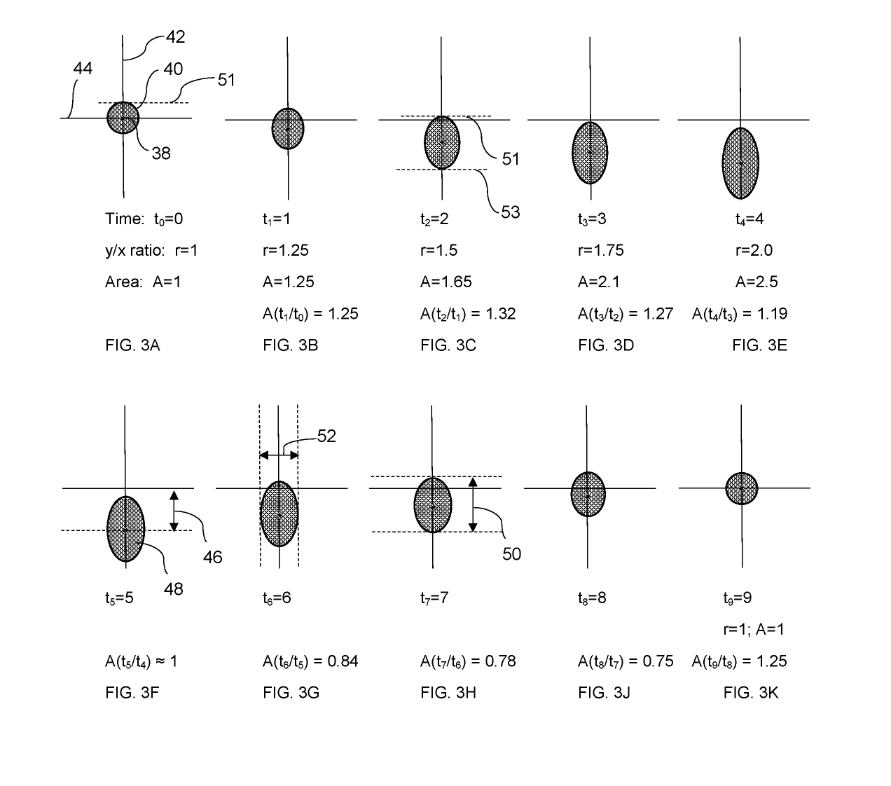

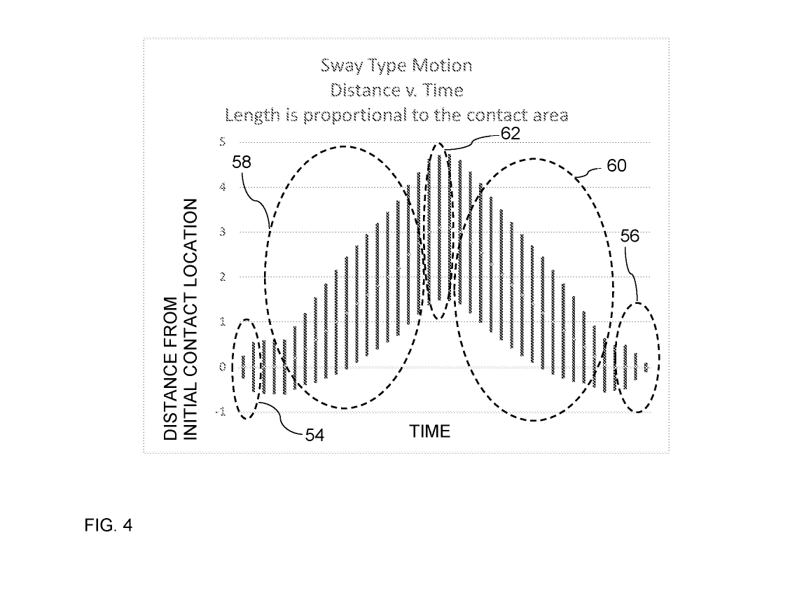

FIG. 3 illustrates features of a 2-dimensional contact between a finger and a surface during a sway. The vertical axis (y-axis) 42 is generally parallel to the projection of the finger onto the surface and measures the length of the contact. The horizontal axis (x-axis) 44 is orthogonal to the vertical axis and measures the width of the contact. The 10 plots show the identical x and y axes and represent sequential times during a sway contact (i.e., t₀<t₁<t₂<t₃<t₄<t₅<t₆<t₇<t₈<t₉). Each of the figures shows the center 38 of the contact and the contact area 40. A positive sway direction is illustrated in the sequence from FIG. 3A to FIG. 3B to FIG. 3C to FIG. 3D to FIG. 3E. During the positive sway, the top 51 (e.g., maximum y location) of the area 40 and the bottom 53 (e.g., minimum y location) of the area 40 preferably both move in a downward direction. During the positive sway, the center 38 of the contact area preferably moves in a downward direction. During the positive sway, the length 50 of the contact preferably increases. During the positive sway, the aspect ratio of the length to the width preferably increases. During the positive sway, the width 52 of the contact may change or may be generally constant. The travel distance 46 increases during the positive sway. A negative sway direction is illustrated in the sequence from FIG. 3F to FIG. 3G to FIG. 3H to FIG. J. During a negative sway, the changes in the contact is generally the opposite of the changes in the contact during a positive sway. For example, during the negative sway, the motion is characterized by one or any combination of the following. the ratio of the length 50 to the width 52 preferably decreases, the length 50 preferably decreases, the contact area 48 preferably decreases, the top 51 of the contact area preferably moves upwards, or the bottom 53. It will be appreciated that a sway may include a positive sway, a negative sway, or both.

FIG. 4 is a contact curve illustrating features that may be observed during a sway contact. It will be appreciated that the only a portion of these features may be observed during a movement that is only a positive sway or only a negative sway. FIG. 4 shows the movement of a contact (e.g., from an initial contact point) during a motion that includes a positive sway followed by a negative sway. During the movement, the contact area and the center point of the contact is observed at regular time intervals. A line is drawn on the graph for each observation. The center point of the line represents the center of the contact area. The length of the line is proportional to the contact area. The contact may include a step of applying a contact to the surface 54. When a contact is applied to a surface, the contact area may increase from zero. FIG. 4 illustrates a contact that initially is static (i.e., at one location). However, it will be appreciated that a finger may be in motion when the contact initiates. The contact may include a forward sway region 60 (i.e., a region representative of a movement in a forward sway direction). The contact curve may include a transition or rest region 62 (e.g., a region where the rocking of the finger has substantially or entirely stopped). The contact curve may include a negative sway region 60. The contact curve may include a contact removal region 56.

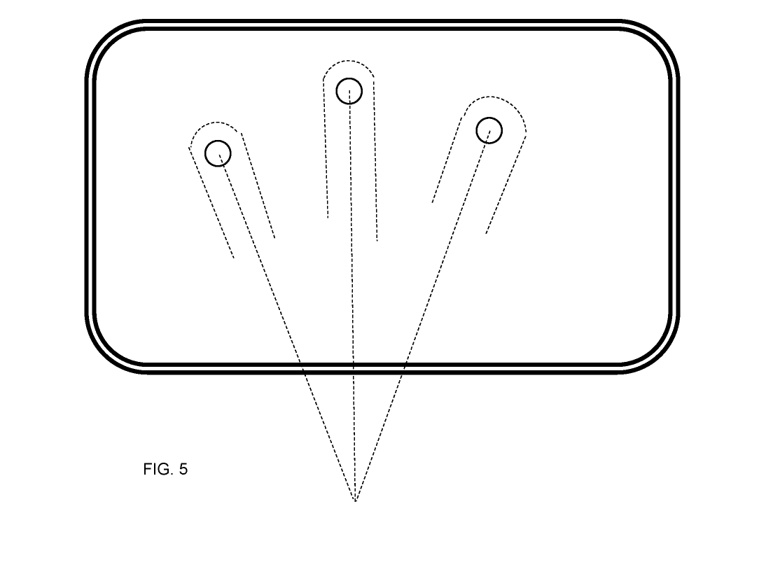

FIG. 5 illustrates the contact (e.g., simultaneous contact) of a surface by a plurality of fingers. When contacted by three or more fingers, a processor may employ the arc shape of the contacts to identify the positive and negative sway directions for each of the contact locations. The different contact locations may be employed for identifying different control regions each associated with a different finger. For example, after contacting the surface with a plurality of fingers, one of the fingers may be maintained in contact with the surface on one or more of the other fingers (e.g., all of the other fingers) may be removed from the surface. The control region(s) in which contact is maintained may be employed for identifying the device or feature to be controlled by the movement (e.g., a movement including a sway motion) of a contact.

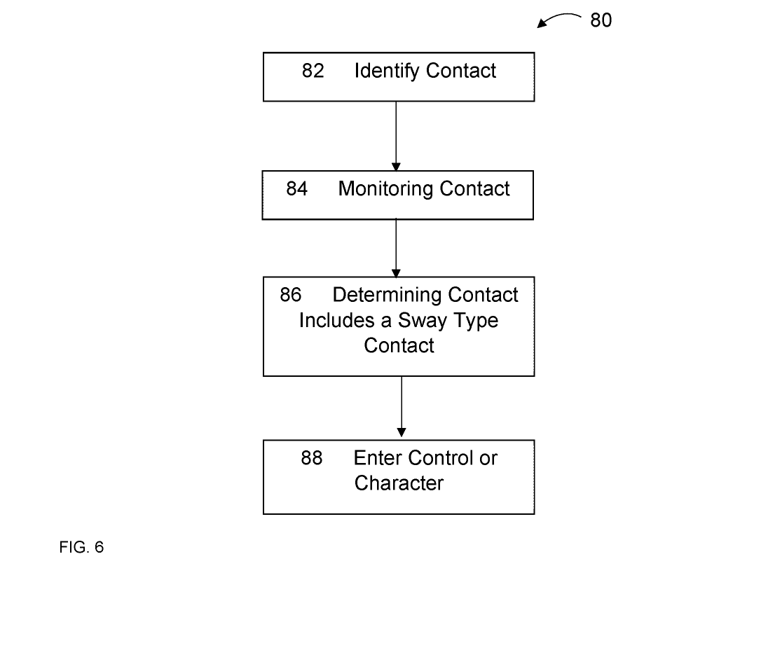

A control process may include one or more of the features illustrated in FIG. 6. The process 80 according to the teachings herein may include a step of identifying a contact 82 on a surface. The process may include a step of monitoring 84 the contact. The monitoring of the contact preferably includes monitoring a movement of the contact (e.g., a movement of the center of the contact). The monitoring of the contact preferably includes a step of monitoring a feature of the shape of the contact (e.g., an area of the contact, an intensity of the contact, a length of the contact a width of the contact, a ratio of a length to a width of the contact). The process may include a step of determining 86 that the contact is a sway type contact. For example, the processor may monitor both the movement of the contact location and the change in the shape of the contact to determine that the contact is characteristic of a sway type contact. The process may include a step of controlling a device (or a feature of a device) and or entering a character 88 after determining that the movement is a sway movement. For a device or feature that has variable control with multiple setting levels, the level of setting may be continuously changed while the sway movement is maintained (e.g., in the same direction or stopped without removal of the contact). The rate of change of the setting level may be related to the travel distance of the sway movement. For example, the rate of change may increase as the travel distance increases.

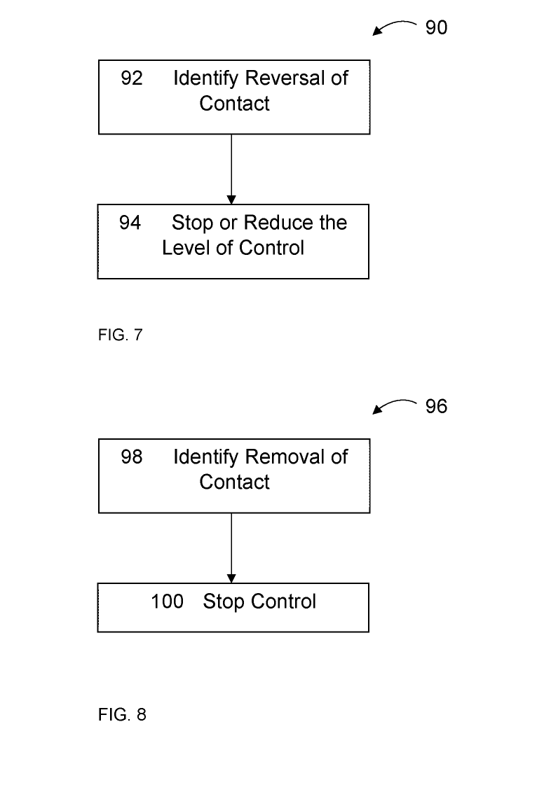

A control process may include one or more of the features illustrated in FIG. 7. The process 90 according to the teachings herein may include a step of identifying 92 the end of sway movement or the reversal of a sway movement. For example, the sway contact may change from a forward sway direction to a negative sway direction. As another example, the movement may be changed to a movement characteristic of a swiping movement (e.g., a movement with substantially no change in contact area). After identifying the change to the swaying motion, the process may then include a step of stopping the control of a device or reducing the level of control (e.g., reduce the rate of change of levels) of a device.

A control process may include one or more of the features illustrated in FIG. 8. The process 96 according to the teachings herein may include a step of identifying 98 the end of sway movement by the removal of the contact from the surface. After identifying the removal of the contact, the process may include a step of stopping the control of a device.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “x” parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

### REFERENCE NUMBERS

10 Finger

11 Surface of the finger

12 Distal phalanx

14 Middle phalanx

15 Fingertip regions

16 Bone

18 Fingernail

20 P1 Contact Point or Location

21 P1 Contact Dimension (e.g., length)

22 P2 Contact Point or Location

23 P2 Contact Dimension (e.g., length)

24 P3 Contact Point or Location

25 P3 Contact Dimension (e.g., length)

26 Forward sway direction

27 Backward sway direction

28 Travel distance

30 P1 Finger orientation

31 Finger angle at P1

32 P2 Finger orientation

33 Finger angle at P2

34 P3 Finger orientation

35 Finger angle at P3

36 Surface (e.g., touch sensitive surface)

38 Center of contact location

40 Contact location

42 Length axis (y-axis)

44 Width axis (x-axis)

46 Contact travel from initial contact location

48 Contact area

50 Contact length

51 Top of contact

52 Contact width

53 Bottom of contact

54 Applying contact

56 Removing contact

58 Forward sway

60 Reverse sway

62 Rest after sway

80 Controlling process

82 Identifying a contact

84 Monitoring a contact

86 Determining contact is a sway type contact

88 Entering a control or character

90 Control process

92 Identifying a reversal of a contact

94 Stopping a control or reducing the level of a control

96 Control process

98 Identifying removal of a contact

100 Stopping a control

We claim:

1. A method for entering a command or character comprising the steps of:
i. a device recognizing an entry contact on a surface including a primary contact at an initial primary contact location;
ii. the device recognizing a swaying motion of the primary contact on the surface;
iii. the device selecting a command or character corresponding to the initial primary contact location.

2. The method of claim 1, wherein the swaying motion includes a first swaying portion wherein the primary contact location moves away from the initial primary contact location (e.g., in a linear fashion) and/or am area of primary contact location increases from an initial area at the initial primary contact location (e.g., corresponding to the rocking of a finger from a fingertip or distal phalanx to a middle phalanx).

3. The method of claim 1, wherein the swaying motion includes a second swaying portion after the first swaying portion characterized by the primary contact location returning towards the initial primary contact location and the area of the primary contact location decreasing towards the initial area of primary contact location (e.g., corresponding to the rocking motion of a finger from a middle phalanx to a distal phalanx or fingertip),

4. The method of claim 1, wherein the initial primary contact is characterized by an initial aspect ratio of a length divided by a width and the swaying motion is characterized by a first portion wherein the primary contact location moves in the length direction and the aspect ratio increases from the initial aspect ratio.

5. The method of claim 1, wherein the primary contact returns to within 30% of the initial primary contact location, based on the maximum distance that the primary contact travels from the initial primary contact location.

6. The method of claim 1, wherein the surface is a touch screen display.

7. The method of claim 1, wherein the surface is not a display surface.

8. The method of claim 1, wherein the entry contact includes a contact at two or more locations including the primary contact and a secondary contact at a second initial contact location.

9. The method of claim 8, wherein the method includes a step of removing the secondary contact from the surface while maintaining the primary contact on the surface.

10. The method of claim 1, wherein the method includes entering the control command, wherein the control command controls a variable device having multiple positions.

11. The method of claim 10, wherein the variable device moves between positions while a swaying contact is maintained (i.e., while the primary contact is maintained on the surface at a position away from the initial primary contact location at a location consistent with a swaying motion).

12. The method of claim 11, wherein the rate of motion of the variable device between positions is controlled by one or more of the following: a change in shape of the primary contact (e.g., the area of the primary contact, a length and/or width of the primary contact, an aspect ratio of the primary contact, or any combinations thereof) or a distance between the primary contact and the initial primary contact location.

13. The method of claim 11, wherein the variable device includes a volume control and the volume is changed continuously (e.g., at a constant rate or at a variable rate) while the swaying contact is maintained.

14. The method of claim 12, wherein the variable device includes a volume control and the rate at which the volume is changed is related to the change in shape of the primary contact location and/or the distance between the primary contact location and the initial primary contact location.

15. The method of claim 1, wherein the method controls a volume of a device, a station selection of a device, a speed of a motor (e.g., an electrical motor), a movement of a cursor, the scrolling of a displayed document or text, a tilt angle of a device, a rotation of a device, a pressure of a device, a power input of a device, a current flow of a device, or an intensity of a light or display.

16. The method of claim 1, wherein the entry contact includes three or more contacts with the surface and the method includes identifying a primary swaying direction corresponding to the primary contact location (e.g., based on the arc shape of the three or more contacts related to the typical anatomy of the distal phalanxes of a human hand).

17. The method of claim 1, wherein the entry contact includes identifying a contact on the surface meeting one or more predetermined criteria (e.g., a contact for a critical time or longer, a contact having an area equal to or greater than a critical area, or an entry contact including a critical number of different contacts).

18. The method of claim 1, wherein the swaying contact is characterized by contact points that are each within 5 mm of a straight line.

19. The method of claim 1, wherein a control of a device begins after the swaying movement travels a critical distance and/or the shape of the primary contact changes by a critical amount.

20. The method of claim 1, wherein the rate of change of a variable setting of a device is proportional to the distance between a primary contact location and an initial primary contact location and/or a change in the shape of the primary contact.

21. The method of claim 1, wherein the method includes a step of entering a character wherein the character is identified by the location of the initial primary contact location, the method includes communicating the character (e.g., by broadcasting the name of the character through speakers or a headphone), wherein the swaying motion is used as a confirmation that the communicated character should be entered).

22. The method of claim 21, wherein a sliding contact (e.g., having generally constant contact area) is identified that passes over multiple character regions of the touch sensitive surface each associated with a character, wherein name of each characters is broadcast upon the sliding contact contacting the associated character region, the sliding motion then stopping at the initial primary contact location for selecting the character, wherein the selected character is entered and rebroadcasted upon identifying the swaying motion.

23. A method of typing one or more character including a step of identifying a contact on a surface, identifying a character corresponding with the location and or type of contact, communicating the character using sound, and entering the character after receiving a confirmation motion (e.g., a swaying motion) on the surface.
